(19) United States
(12) Patent Application Publication
(10) Pub. No.: US 2025/0076625 A1
(43) Pub. Date: Mar. 6, 2025

(54) ADAPTER TIP AND MICROSCOPE SYSTEM FOR INSPECTING ANGLED-POLISHED OPTICAL-FIBER CONNECTORS

(71) Applicant: EXFO Inc., Quebec (CA)

(72) Inventors: Olivier COTE, Quebec (CA); Charles GAUVIN, Quebec (CA)

(21) Appl. No.: 18/808,583

(22) Filed: Aug. 19, 2024

Related U.S. Application Data
(60) Provisional application No. 63/579,073, filed on Aug. 28, 2023.

(51) Int. Cl. G02B 21/00; G02B 6/38

(52) U.S. Cl. CPC G02B 21/0032; G02B 6/3825; G02B 21/0016

(57) ABSTRACT

There is provided an adapter tip to be employed with an optical-fiber connector-endface inspection microscope device and an optical-fiber connector endface inspection microscope system suitable for imaging angled-polished optical-fiber endface(s) of an optical-fiber connector. The proposed adapter tip or microscope system comprises relay optics comprising a multifaceted optical prism defining a first reflecting plane surface, a second reflecting plane surface and a third reflecting plane surface, used to deflect inspection light coming from the endface(s) through reflection of illumination light—referred to hereinafter as the object beam—towards and substantially in line with the optical axis of the objective lens of the optical-fiber connector-endface inspection microscope device.

### TECHNICAL FIELD

The present description generally relates to inspection of optical-fiber connector endfaces and more specifically to adapter tips, to be used in conjunction with an optical-fiber connector endface inspection microscope device and suitable for imaging angled-polished optical-fiber endfaces of an optical-fiber connector.

### BACKGROUND

The quality and cleanliness of endfaces of optical-fiber connectors represent key factors for achieving adequate system performance of optical communication networks. Indeed, any contamination of or damage on the mating surface of an optical-fiber connector may severely degrade signal integrity. Optical-fiber inspection microscopes are commonly employed to visually inspect and/or to analyze the optical-fiber endface of an optical-fiber connector at installation or during maintenance of optical communication networks, in order to verify the quality of the optical-fiber connection.

Because of the wide variety of optical-fiber connector types deployed in the telecommunication industry, optical-fiber connector endface inspection microscopes are typically employed with interchangeable adapter tips so as to allow inspection of various types of optical-fiber connectors directly or as inserted in an optical-fiber connector adapter. Optical-fiber connector endface inspection microscopes are therefore typically designed for use with an adapter tip selected among a plurality of adapter tip types.

Optical-fiber connectors to be inspected can be single-fiber, multi-fiber (8 fibers or more) or duplex, and the inspected connector endface may be either non-angled polished (UPC connectors) or angled-polished (APC connectors), i.e., polished at an 8-degree angle respective to the optical fiber axis. Some inspection microscopes allow to inspect all these varieties of connectors by simply changing the adapter tip.

Conventional methods for inspecting APC connectors involve tilting the inspection microscope at an 8-degree angle relative to the optical fiber axis in order to illuminate the connector endface in a direction normal to the angled-polished endface.

However, APC connectors are often installed in very dense patch panels where optical-fiber connection are positioned close to one another, and it may therefore be impossible to insert inspection probe at angle without disconnecting neighbor optical-fiber connectors (see FIGS. 1B and 1C). Disconnecting represents a huge disadvantage because a disconnected fiber has an increased chance of dust contamination or being scratched.

More recently introduced connectors include APC multifiber connectors (such as the MPO-APC connector), which raise issues not addressed by the prior art adapter tips for inspection in dense environments.

Some single-fiber adapter tips exist (see, e.g., U.S. Pat. No. 9,880,359B2) which comprise an arrangement of lenses which serves to deviate the reflected light beam and to inspect the APC connector without having to tilt the inspection microscope device relative to the optical fiber and connector. However, this prior art design can only inspect one fiber at a time and cannot be used to image endfaces of an APC multifiber connector.

In other solutions (see, e.g., US20220035104A1 and US20030179447), a rhomboid or a two-mirror arrangement can be used to keep lenses as close as possible to the optical axis of the inspection microscope. But although the optical axis of the probe is parallel to the optical fiber axis, it remains laterally shifted.

There therefore remains a need for a solution allowing to inspect angled-polished optical-fiber endfaces of an optical-fiber connector while keeping the inspection microscope in line with the optical-fiber connector under inspection.

### SUMMARY

There is provided an adapter tip to be employed with an optical-fiber connector-endface inspection microscope device and an optical-fiber connector endface inspection microscope system suitable for imaging angled-polished optical-fiber endface(s) of an optical-fiber connector (recessed or not in a connector adapter, sometimes also referred to as a bulkhead). The proposed adapter tip or microscope system comprises relay optics comprising a multifaceted optical prism defining a first reflecting plane surface, a second reflecting plane surface and a third reflecting plane surface, used to realign inspection light coming from the endface(s) through reflection of the illumination light (mostly specular but also potentially diffuse)—referred to hereinafter as the object beam—towards and substantially in line with the optical axis of the objective lens of the optical-fiber connector-endface inspection microscope device.

This configuration may advantageously be used for inspecting multifiber optical-fiber connectors. In such cases, in the inspection microscope, the multiple endfaces can be imaged on the same image sensor or using two image sensors (e.g., as sometimes used in the art in multifiber inspection microscopes in order to obtain a wider field of view necessary for multifiber connector inspection).

In accordance with one aspect, there is provided an adapter tip to be employed with an optical-fiber connector endface inspection microscope comprising an objective lens, for imaging at least one angled-polished optical-fiber endface of an optical-fiber connector, the adapter tip comprising:
a housing having:
   a mating interface on one end, configured to mechanically engage with the optical-fiber connector for inspecting the optical-fiber endface;
   a connection mechanism on the other end, to releasably attach to the inspection microscope; and
   a hollow body extending between the one end and the other end and allowing inspection light reflected from the optical-fiber endface to propagate to the objective lens of the inspection microscope; and
relay optics disposed in said hollow body of said housing and comprising a multifaceted optical prism disposed so as to receive inspection light reflected from said angled-polished optical-fiber endface during inspection and relay said inspection light to an objective lens of the inspection microscope, the multifaceted optical prism defining a first reflecting plane surface, a second reflecting plane surface and a third reflecting plane surface, wherein said first reflecting plane surface and said third reflecting plane surface are tilted in opposite directions relative to said second reflecting plane surface so as to deflect a propagation axis of said inspection light towards an optical axis of the objective lens through reflection on said first reflecting plane surface, said second reflecting plane surface and said third reflecting plane surface.

In accordance with another aspect, there is provided an optical-fiber connector endface inspection microscope system for imaging at least one angled-polished optical-fiber endface of an optical-fiber connector, the inspection microscope system comprising:
an optical-fiber connector endface inspection microscope device having an objective lens; and
an adapter tip connectable to the optical-fiber connector endface inspection microscope device and comprising:
   a housing having:
      a mating interface on one end, configured to mechanically engage with the optical-fiber connector for inspecting the optical-fiber endface;
      a connection mechanism on the other end, to releasably attach to the inspection microscope; and
      a hollow body extending between the one end and the other end and allowing light reflected from the optical-fiber endface to propagate to the objective lens of the inspection microscope; and
   relay optics disposed in said hollow body of said housing and comprising a multifaceted optical prism disposed so as to receive inspection light reflected from said angled-polished optical-fiber endface during inspection and relay said inspection light to an objective lens of the inspection microscope, the multifaceted optical prism defining a first reflecting plane surface, a second reflecting plane surface and a third reflecting plane surface, wherein said first reflecting plane surface and said third reflecting plane surface are tilted in opposite directions relative to said second reflecting plane surface so as to deflect a propagation axis of said inspection light towards an optical axis of the objective lens through reflection on said first reflecting plane surface, said second reflecting plane surface and said third reflecting plane surface.

Compared to other prior art solutions, the multifaceted optical prism allows to keep the inspection microscope in line and centered on the angled-polished multifiber optical-fiber connector under inspection, as well as keeping all components optimally compact transversally.

In some embodiments, said optical-fiber connector is a multifiber optical-fiber connector comprising multiple angled-polished optical-fiber endfaces.

In some embodiments, said housing is configured so as to substantially align a center longitudinal axis of said optical-fiber connector with the optical axis of the objective lens.

In some embodiments, said first reflecting plane surface is tilted relative to said second reflecting plane surface with a first angle and said third reflecting plane surface is tilted relative to said second reflecting plane surface with a second angle, wherein said first angle and said second angle have a difference of about 4 degrees.

In some embodiments, said first reflecting plane surface receives inspection light on an angle of incidence that is not normal thereto and reflects inspection light toward said second reflecting plane surface, which reflects inspection light toward said third reflecting plane surface, which in turn reflects inspection light toward said inspection microscope and substantially aligned and centered on the optical axis of the objective lens of the inspection microscope.

In some embodiments, inspection light is reflected on said first reflecting plane surface, said second reflecting plane surface and said third reflecting plane surface via total internal reflection.

In some embodiments, said first reflecting plane surface, said second reflecting plane surface and said third reflecting plane surface each comprises a reflection coating.

In some embodiments, said second reflecting plane surface is substantially parallel to the optical axis of the objective lens and wherein said multifaceted optical prism is affixed in said housing such that said second reflecting plane surface abuts an internal surface machined in said housing.

In some embodiments, said multifaceted optical prism comprises a first prism and second prism joint to one another so as to form said multifaceted optical prism.

In some embodiments, said first prism comprises a first surface defining said first reflecting plane surface and said second prism comprises a second surface defining said second reflecting plane surface and a third surface defining said third reflecting plane surface.

In some embodiments, said first prism further comprises a fourth plane surface and wherein said first prism and said second prism are joint to one another by affixing said fourth plane surface on a portion of said third surface.

In some embodiments, said relay optics comprises collimating lenses, said multifaceted optical prism being disposed in-between said optical-fiber connector under inspection and said collimating lenses.

In some embodiments, said relay optics produces an intermediate image plane between said relay optics and the objective lens of the inspection microscope.

In this specification, unless otherwise mentioned, word modifiers such as “substantially” and “about” which modify a value, condition, relationship or characteristic of a feature or features of an embodiment, should be understood to mean that the value, condition, relationship or characteristic is defined to within manufacturing tolerances that are acceptable for proper operation of this embodiment in the context its intended application.

Further features and advantages of the present invention will become apparent to those of ordinary skill in the art upon reading of the following description, taken in conjunction with the appended drawings.

The following description is provided to gain a comprehensive understanding of the methods, apparatus and/or systems described herein. Various changes, modifications, and equivalents of the methods, apparatuses and/or systems described herein will suggest themselves to those of ordinary skill in the art. Description of well-known functions and structures may be omitted to enhance clarity and conciseness.

Although some features may be described with respect to individual exemplary embodiments, aspects need not be limited there to such that features from one or more exemplary embodiments may be combinable with other features from one or more exemplary embodiments.

### BRIEF DESCRIPTION OF THE DRAWINGS

FIG. 1A (PRIOR ART) is a perspective view of an angled-polished (APC) multifiber connector of the type MPO-APC.

FIG. 1B (PRIOR ART) is a cross-sectional view of an inspection probe engaged to a non-angled polished (UPC) multifiber connector for inspection.

FIG. 1C (PRIOR ART) is a cross-sectional view of an inspection probe engaged to an angled-polished (APC) multifiber connector for inspection in a dense connection environment.

FIG. 2 is a back-perspective view of an optical-fiber connector endface inspection microscope coupled to an adapter tip for imaging optical-fiber endfaces of an APC multifiber connector optical-fiber connector, in accordance with one embodiment.

FIG. 3 is a back-perspective view of the optical-fiber connector endface inspection microscope of FIG. 2, wherein optical-fiber connector and connector adapter are exploded from the optical-fiber connector endface inspection microscope.

FIG. 4 is a cross-sectional view of the optical-fiber connector endface inspection microscope of FIG. 2.

FIG. 5 is a top plan schematic of the optical configuration of the optical-fiber connector endface inspection microscope and adapter tip of FIG. 2, in accordance with one embodiment wherein the adapter tip is short reach.

FIG. 6 is a side elevation schematic of the optical configuration of the optical-fiber connector endface inspection microscope and adapter tip of FIG. 2, in accordance with another embodiment wherein the adapter tip is long reach.

FIG. 7 is a side elevation view of the multifaceted optical prism of the adapter tip of FIGS. 5 and 6, showing reflection angles in the prism.

FIG. 8 is a side elevation schematic of the optical configuration of the adapter tip of FIG. 5.

FIG. 9 is a side elevation view of the multifaceted optical prism of the adapter tip of FIGS. 5 and 6, showing dimensions and angles of the prism.

FIG. 10 is a side elevation view of the multifaceted optical prism of the adapter tip of FIGS. 5 and 6, also showing connector pins.

FIG. 11 is a perspective view of the adapter tip of FIG. 2.

FIG. 12A is bottom plan view, FIG. 12B is a right-side elevation view, FIG. 12C is a top plan view, FIG. 12D is a left-side elevation view, FIG. 12E is a front elevation view and FIG. 12F is a back elevation view of the adapter tip of FIG. 11.

FIG. 13 is an exploded perspective view of the adapter tip of FIG. 11.

FIG. 14A is across-sectional view of the adapter tip of FIG. 11 along line A-A of FIG. 14B; and FIG. 14B is a right-side elevation view of the adapter tip of FIG. 11.

FIG. 15 is a side elevation view of a multifaceted optical prism in accordance with another embodiment.

FIG. 16 is a side elevation schematic of the optical configuration of an adapter tip in accordance with another embodiment.

FIG. 17 is a side elevation view of a multifaceted optical prism in accordance with another embodiment comprising a third optical prism.

FIG. 18 is a block diagram illustrating an example architecture of an optical-fiber connector endface inspection microscope device.

It will be noted that throughout the drawings, like features are identified by like reference numerals. In the following description, similar features in the drawings have been given similar reference numerals and, to not unduly encumber the figures, some elements may not be indicated on some figures if they were already identified in a preceding figure. It should be understood herein that elements of the drawings are not necessarily depicted to scale, since emphasis is placed upon clearly illustrating the elements and structures of the present embodiments. Some mechanical or other physical components may also be omitted in order to not encumber the figures.

### DETAILED DESCRIPTION

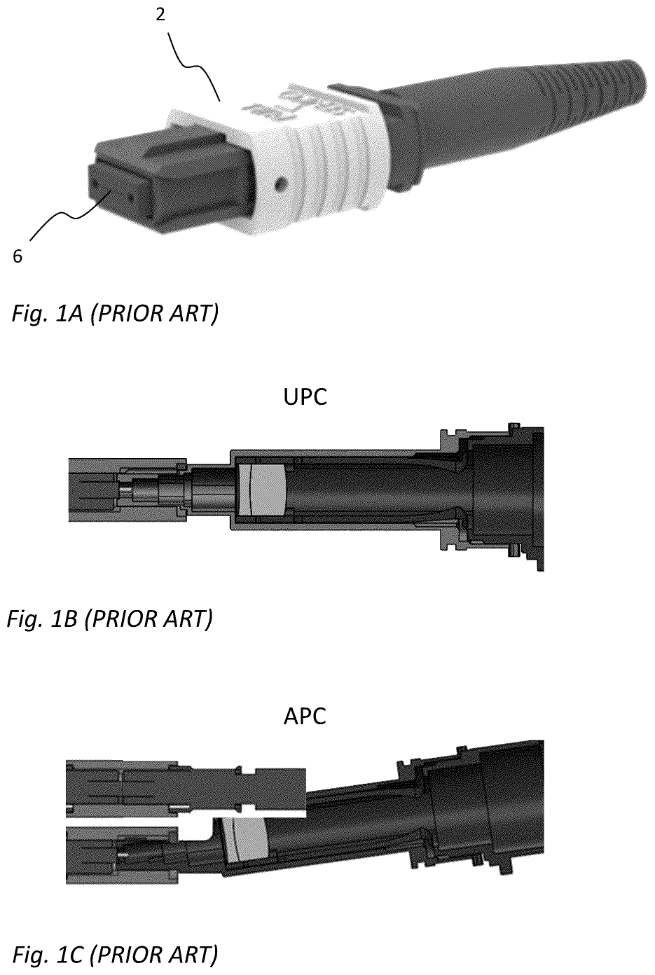

Now referring to the drawings, FIG. 1A illustrate an angled-polished (APC) multifiber connector. As shown, the APC multifiber connector multiple optical-fiber enfaces 6. In the illustrated case, the endface of the APC multifiber connector comprises twelve optical-fiber enfaces but this number may vary, including, e.g., 8, 12, 16 or 24. In the case of APC multifiber connectors, the optical-fiber endfaces are angled-polished (APC) at an angle of 8 degrees relative to their respective optical-fiber axes.

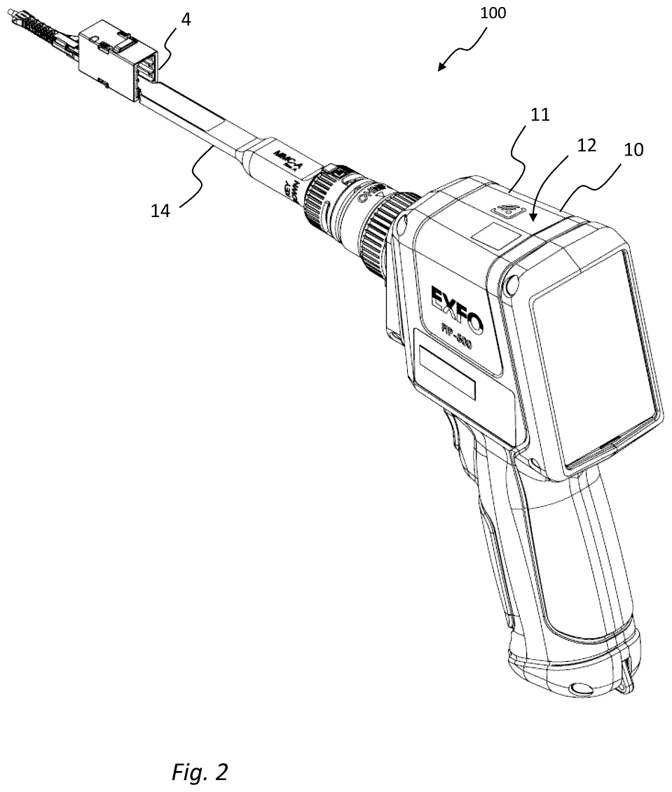

FIGS. 2, 3 and 4 illustrate an optical-fiber connector endface inspection microscope system 100 for imaging the optical-fiber endfaces of multifiber optical-fiber connectors such as the APC multifiber connector 2. In some applications, the optical-fiber connector 2 to be inspected using an optical-fiber connector endface inspection microscope system 100 is inserted in a connector adapter (not shown). As known in the art, connector adapters are used to interconnect two optical fibers terminated by optical-fiber connectors such as connector 2. In order for the endfaces of the optical fibers to be brought into close contact, optical-fiber connectors employ fiber-optic ferrules 6 (see FIG. 1A) in which the terminated portion of an optical fiber is inserted. The fiber-optic ferrule 6 and optical fiber assembly is polished at the termination, either perpendicularly to the optical fiber axis or at an 8-degree angle in the case of APC connectors, so as to form a ferrule endface enclosing the optical-fiber endface(s).

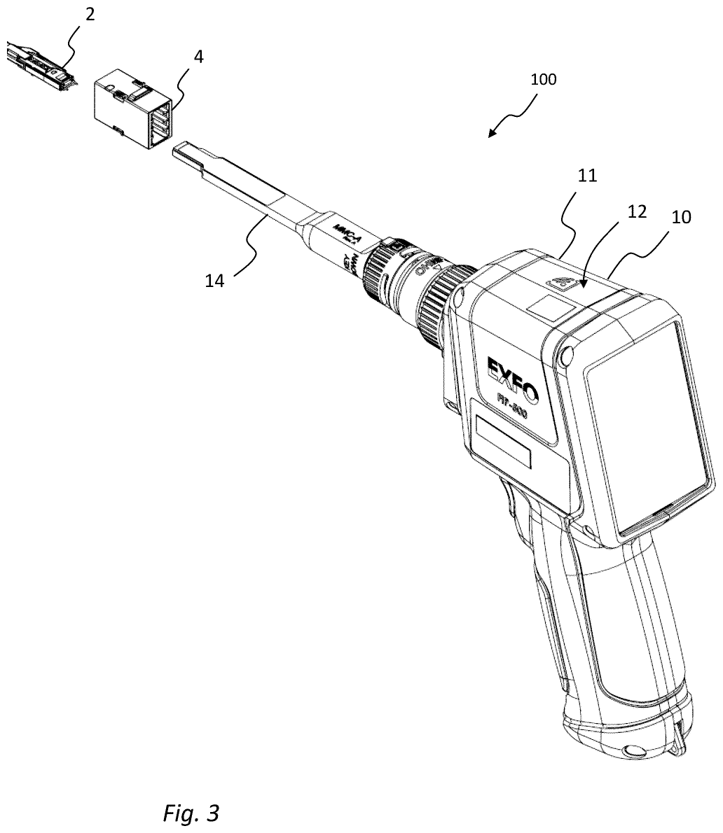

Referring to FIGS. 2 and 3, the optical-fiber inspection microscope system 100 comprises an inspection microscope device 10 comprising a main housing structure 11 enclosing an optical-fiber connector endface inspection microscope 12, and an interchangeable adapter tip 14. It will be understood that the configuration of FIGS. 2 and 3 illustrates one example embodiment of an optical-fiber connector endface inspection microscope system. It should be appreciated by those of ordinary skill in the art that various implementations of the inspection microscope device can be envisaged as known in the art and that the embodiment illustrated herein is no way meant to be limitative.

The inspection microscope device 10 is an inspection microscope device adapted to be employed with a variety of interchangeable adapter tips so as to allow inspection of various types of optical-fiber connectors directly or as inserted in an optical-fiber connector adapter 4. The adapter tip 14 and the inspection microscope device 10 together form an inspection microscope system 100.

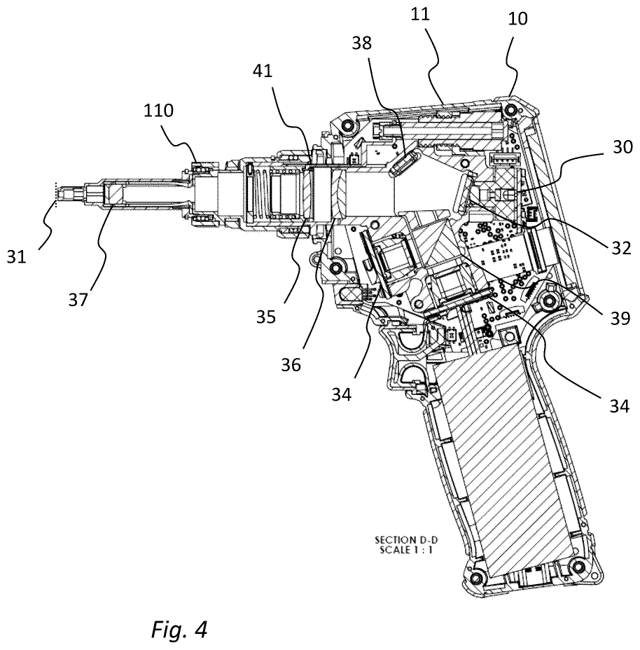

The most common adapter tips employed for inspecting single-fiber or multifiber connectors are mostly mechanical adapters that do not include any optical elements. The input lens of the inspection microscope 12 is referred to herein as the “objective lens” 37 (see FIG. 4).

The illustrated adapter tip 14 is suitable for imaging the optical-fiber endface of an APC multifiber optical-fiber connector 2 and is designed to interface the inspection microscope device 10 with an optical-fiber connector 2 that is inserted in a connector adapter 4. That being said, in order to inspect multifiber optical-fiber patch cord connectors 2 (i.e., not inserted in a connector adapter 4), one simply needs to connect a connector adapter 4 to the optical-fiber connector to be inspected. Although the embodiment illustrated herein is configured to interface with APC multifiber connectors, it should be understood that its mechanical and optical elements may be modified to interface with other formats of angled-polished single-fiber or multifiber optical-fiber connectors and connector adapters, comprising any number of optical fiber endfaces, including 1, 2, 8, 12, 16 or 24 optical fiber endface(s). It may further be modified to directly interface with optical-fiber patch cord connectors 2 (i.e., without using a connector adapter 4).

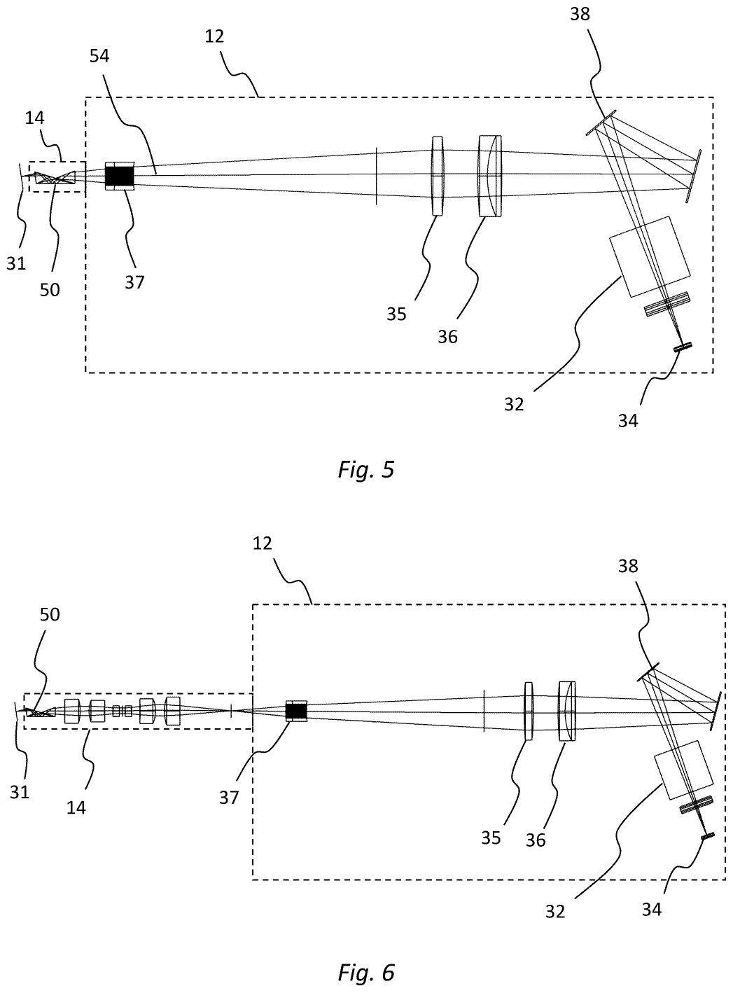

Referring to FIGS. 4, 5 and 6, generally, an inspection microscope device 10 incorporates an imaging assembly comprising an illumination source arrangement 30, an illumination beam splitter 32, one or more image sensors 34 (two image sensors in the embodiment of FIG. 4 and a single one in that of FIGS. 5 and 6) and imaging optics. The illumination source arrangement 30 illuminates the connector endface to be inspected and which lies on an object plane 31. The illumination beam splitter 32 directs illumination light toward the connector endface. The image sensor(s) 34 captures at least one image of the endface to be inspected. The imaging optics comprises an objective lens system 35, 36, 37 (and optionally other lenses, mirrors (see, e.g., 38) and/or other optical components (e.g., beamsplitter 39)), for imaging the illuminated connector endface, on the image plane(s) coinciding with the image sensor(s) 34. The object plane 31 as defined herein coincides with the plane where the connector endface to be inspected (i.e., the object) should be positioned relative to the objective lens system (within the focusing range thereof) to be suitably imaged on the image sensor(s) 34. The optical path between the object plane 31 and the image plane defines an imaging path of the inspection microscope 12, along which propagates the inspection light beam resulting from a reflection of illumination light on the connector endface, for optical magnification of the object (i.e., the connector endface) positioned on the object plane 31.

More specifically, the objective lens system of the embodiment of FIG. 4 comprises a focusing lens 35 for adjusting a focus of the objective lens system (here movable using the actuator 41) and some fixed lenses 36, 37. It will be understood that the objective lens system may further comprise other lenses or optical elements as required by the optical design, which lenses and optical elements can be either fixed relative to the microscope system or movable, e.g., held fixed with the focusing lens.

It is noted that in other embodiments, focus may be adjusted using a deformable focusing lens instead of a movable focusing lens. In such case, the focusing lens 35 may also remain fixed during focus adjustment.

In the embodiment of FIG. 4, two image sensors 34 are disposed so as to capture images of respective regions over the connector endface (i.e., left and right regions of the connector endface). The light beam reflected on the inspected endface is split among the two image sensors 34 using the beamsplitter 39 and is split so as to produce an image of a left-side region of the connector endface on one image sensor 34 and an image of a right-side region on the other image sensor 34. This is achieved by adequately offsetting each image detectors relative to the center axis of the optical system. The two images may be stitched in processing to obtain a single image covering the whole region of interest over the connector endface. Such configuration can be useful, e.g., for multifiber connector inspection and may also be used for duplex connector inspection.

As shown in the embodiment of FIGS. 5 and 6, it is also possible to use a single image sensor 34 to cover the whole region of interest over the connector endface, depending on the available technology and required image resolution.

FIG. 5 illustrates the case of a short reach adapter tip 14, whereas FIG. 6 illustrates the case of a long reach adapter tip 14. The difference lies in that the long reach adapter of FIG. 6 comprises additional collimating lenses 122 used to elongate the adapter tip 14 for easier insertion between patch cords, i.e., in dense connection environments.

In the case of multifiber connectors such as that shown in FIG. 1A, the connector endface includes multiple optical fibers 6 (e.g., 8, 12, 16 or 24), each defining an optical-fiber endface to be inspected. As known in the art, in order to properly image the optical-fiber endface, the light beam reflected from the endface (through reflection of the illumination light on the connector endface) should be appropriately collected by the inspection microscope objective lens 37. This is generally obtained by positioning the inspection microscope such that illumination light is projected and reflects in a direction that is normal to the inspected optical-fiber endfaces. Therefore, conventional methods for inspecting APC connectors involve tilting the inspection microscope at an 8-degree angle relative to the longitudinal axis of the optical-fiber connector in order to illuminate the connector endface in a direction normal to the angled-polished endface.

However, referring to FIGS. 1B and 1C, APC connectors are often installed in very dense environments, and it may therefore be impossible to insert inspection probe at angle without disconnecting neighbor optical-fiber connectors (see FIGS. 1B and 1C). FIG. 1B illustrates an inspection probe engaged to a non-angled polished (UPC) multifiber connector for inspection. The straight alignment of the inspection probe relative to the inspected connector allows inspection in dense connection environments. In contrast, FIG. 1C illustrated a prior art inspection probe engaged for inspection of an angled-polished (APC) multifiber connector and shows that it may interfere with neighbor patch cords in a dense connection environment.

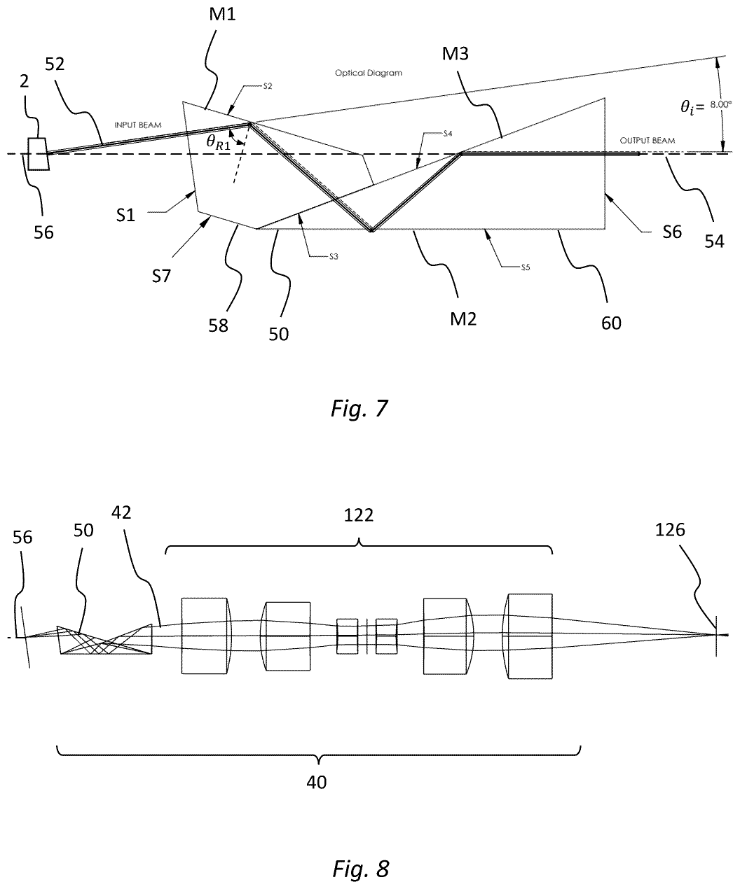

Referring to FIGS. 5, 6, 7, 8, in order to allow APC connector inspection without having to disconnect the neighbor optical fibers, the inspection microscope system 100 therefore comprises an adapter tip 14 comprising a multifaceted optical prism 50 which is used to deflect a propagation axis 52 of inspection light coming from the endfaces (through reflection of the illumination light), towards and substantially in line with the optical axis 54 of the objective lens 37 of the optical-fiber connector-endface inspection microscope device 10. This is achieved through reflection on a first reflecting plane surface M1, a second reflecting plane surface M2 and a third reflecting plane surface M3 of the multifaceted optical prism 50 (see FIG. 7). This configuration provides an adapter tip 14 that is transversally compact so as to allow insertion between neighbor optical-fiber connections in dense patch panels.

Referring to FIGS. 5, 6, 7 and 8, the adapter tip 14 is described in more detail. The adapter tip 14 comprises relay optics 40 configured to deflect the propagation axis 52 of inspection light towards the optical axis 54 of the objective lens. The adapter tip 14 comprises a multifaceted optical prism 50 disposed so as to receive inspection light reflected from the angled-polished optical-fiber endfaces and relay such inspection light to the objective lens. The multifaceted optical prism 50 defines a first reflecting plane surface M1, a second reflecting plane surface M2 and a third reflecting plane surface M3.

As shown in FIG. 7, reflecting surface M1 and reflecting surface M3 are tilted in opposite directions relative to reflecting surface M2 so as to deflect the propagation axis 52 towards the optical axis 54 of the objective lens through reflection on reflecting surfaces M1, M2 and M3, in this order.

In the embodiment of FIGS. 6 and 8, the relay optics 40 further comprises optional collimating lenses 122 along the imaging path, which focal points are designed to substantially collimate the light beam 42 between the collimating lenses 122 and reproduce the object lying on the object plane 31, on an intermediate image plane 126 for proper imaging using the inspection microscope 12. The multifaceted optical prism 50 is disposed in-between the optical-fiber connector 2 under inspection and the collimating lenses 122 and the intermediate image plane 126 lies between the relay optics 40 and the objective lens 37 of the inspection microscope.

In this embodiment, the collimating lenses 122 comprise three pairs of singlet collimating lenses. It will however be understood that other embodiments may use a single pair of complex lenses such as doublet or triplet lenses. Other combinations are also possible.

In this embodiment, the collimating lenses 122 are used to elongate the adapter tip 14 relative to a nominal length dictated by the focal length of the objective lens system 35, 36, 37 and increase the distance between the object plane 31 and the objective lens 37, so as to allow to reach optical connectors that are recessed in a dense environment such as a patch panel. It is however noted that collimating lenses 122 may be optional. For example, other designs of the objective lens system and/or adapter tip 14 may be envisaged, which designs may not necessitate collimating lenses 122.

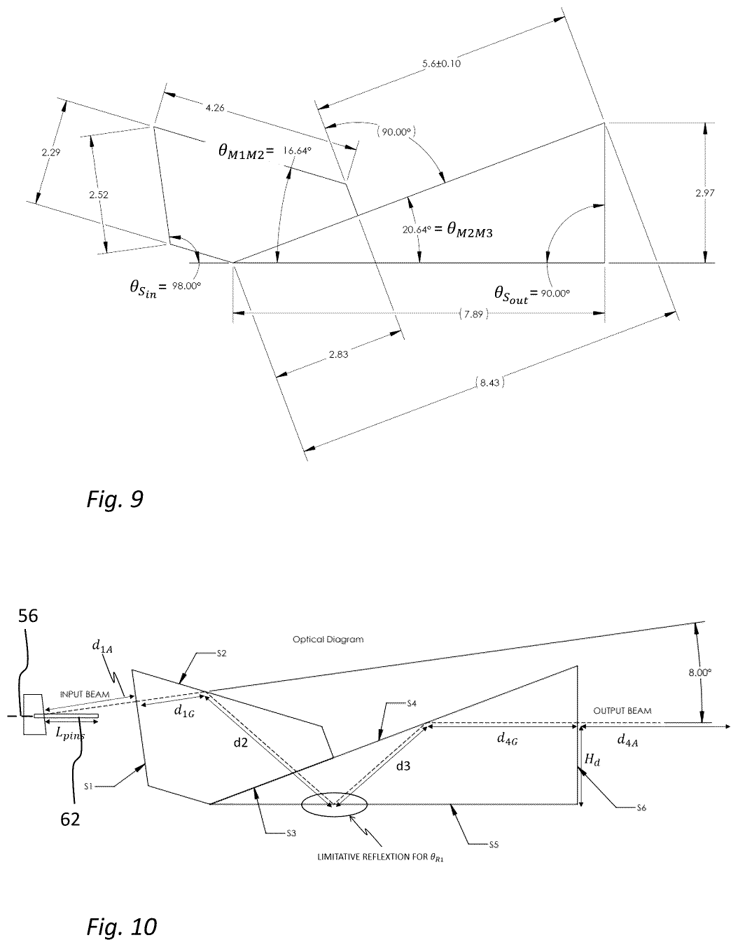

Referring to FIGS. 7, 9 and 10, the multifaceted optical prism 50 is described in more detail. The multifaceted optical prism 50 is designed to receive a light beam on the input face S1 and deflect its propagation axis 52 of an angle of 8° (θᵢ) so it outputs the multifaceted optical prism 50 in a direction that is substantially parallel, and preferably substantially aligned, with the center longitudinal axis of the multifiber optical-fiber connector 2. This allows a construction where the center longitudinal axis of the multifiber optical-fiber connector can be made substantially aligned with the optical axis 54 of the inspection microscope 12.

The multifaceted optical prism 50 consists in a modified version of a reversion prism (see, e.g., SMITH, Warren J., “Modern Optical Engineering”, SPIE Press, Fourth edition, 2008, pp. 144-145). Both the multifaceted optical prism 50 and the reversion prism comprise an input face S1, an output face S6, a reflecting surface M1, a center reflecting surface M2 and a reflecting surface M3 and reflecting surfaces M1 and M3 are tilted in opposite directions relative to the center reflecting surface M2 so as to open respectively toward the input face S1 and the output face S6. Traditionally, a reversion prism is known to be made symmetric, i.e., reflecting surface M1 forms an angle θ_{M1M2} with the center reflecting surface M2 and reflecting surface M3 forms an angle θ_{M2M3} with the center reflecting surface M2. The input face S1 and output face S6 also form a right angle with the center reflecting surface M2. Conversely, reflecting surfaces M1 and M3 of the multifaceted optical prism 50 have different angles relative to the center reflecting surface M2 (θ_{M1M2}≠θ_{M2M3}) and the input face S1 has a tilt θ_{Sin}=8° relative to the output face S6.

Angles of the reflecting surfaces M1 and M3 are selected so as to induce an 8° deflection of the propagation axis of the inspection light, from the input to the output of the optical prism 50. In the illustrated embodiment, light reaches the optical prism 50 at an angle θᵢ of 8° relative to the center reflecting surface M2 and exits at 0°.

This effect is obtained by tilting reflecting surfaces M1 and M3 at different angles relative to the center reflecting surface M2 such that the difference corresponds to θᵢ/2=4°, i.e.:

$${θ}_{M 2 M 3} = {θ}_{M 1 M 2} + {θ}_{i} / 2$$

It is noted that the deflection angle θᵢ is herein selected so as to correspond to the angle of the angled-polished endface, i.e., 8°, but can be modified should the endface be angled-polished at a different angle.

Here, the center reflecting surface M2 is positioned such that it is parallel to the optical axis 54 of the objective lens 37 and the center longitudinal axis 56 of said multifiber optical-fiber connector 2. Such positioning facilitates the calculation of the angles as well as the manufacturing of the adapter tip 14 (it makes it easier to align the multifaceted optical prism 50 in the adapter tip 14). However, it is noted that in other embodiments, the center reflecting surface M2 could be made slightly tilted relative to the optical axis 54 and/or the center longitudinal axis 56.

The multifaceted optical prism 50 is configured such that inspection light is received with its propagation axis 52 being substantially normal to the input face S1. Inspection light then reaches the reflecting surface M1 on an angle of incidence θ_{R1} that is not normal thereto so that reflecting surface M1 reflects inspection light toward said reflecting surface M2, which then reflects inspection light toward reflecting surface M3, which in turn reflects inspection light substantially normal to the output face S6.

In the illustrated embodiment, reflection on surfaces M1, M2 and M3 is obtained by total internal reflection. There is therefore no need for reflection coatings. It is however noted that other embodiments may comprise reflection coatings on reflecting surfaces M1, M2 and M3, e.g., so to provide more flexibility on the angles of incidence. On the contrary, anti-reflection coatings may optionally be used on the input face S1 and the output face S6 for better optical transmission.

One advantage of using such multifaceted optical prism 50 in the adapter tip 14 is that the distances between each reflecting surfaces M1, M2, M3 can be designed so as to substantially align a center longitudinal axis 56 of the multifiber connector 2 with the optical axis 54 of the inspection microscope. As explained herein above, such design can be used to make the adapter tip 14 optimally compact transversally. However, in other cases where an offset may be desired between the multifiber connector 2 under inspection and the optical axis 54 of the inspection microscope 12, it is possible to adjust the distances between the reflecting surfaces M1, M2, M3 in order to create such desired offset.

Furthermore, by selecting the material used to manufacture the optical prism 50 (and therefore its refracting index), it is possible to control the distance between the multifiber connector 2 under inspection and the inspection microscope 12. A lower refracting index will produce a shorter distance between the objective lens 37 and multifiber connector 2, whereas a greater refracting index will do the opposite.

Moreover, while the illustrated multifaceted optical prism 50 is designed for an 8° angle of the input beam, its design may be modified to correct input beams that are incident at any arbitrary angle.

It is further noted that although the illustrated embodiments are adapted for inspecting APC multifiber optical-fiber connectors, the optical configuration described herein may also be useful and adapted for inspecting single-fiber APC connectors.

In the illustrated embodiment, the multifaceted optical prism 50 is constructed by assembling a first prism 58 and second prism 60, which are joint to one another (e.g., using optical cement) so as to form multifaceted optical prism 50. The first prism 58 comprises a surface S2 defining the first reflecting plane surface M1 and the second prism 60 comprises a surface S5 defining the second reflecting plane surface M2 and a surface S4 defining the third reflecting plane surface M3. The first prism 58 further comprises a surface S3, wherein the first prism 58 and the second prism 60 are joint to one another by affixing surface S3 on a portion of surface S4 of the second prism 60.

This two-part construction is used to facilitate the manufacturing of the multifaceted optical prism 50 but other constructions may also be envisaged.

In the illustrated embodiment, the angles of the reflecting plane surfaces M1, M2 and M3 and the input and output faces S1, S6 may be determined as follows. It will be understood that ideal values of angles are herein calculated but that the actual angles of the optical prism 50 may slightly vary, e.g., within manufacturing tolerances that are acceptable for proper operation of this embodiment in the context its intended application. In this embodiment, the center reflecting surface M2 is positioned such that it is parallel to the optical axis 54 of the objective lens 37 and the center longitudinal axis 56 of said multifiber optical-fiber connector 2. In the following, the angles of the other surfaces are defined using the center reflecting surface M2 as a reference.

The angle θ_{Sin} of the input face S1 is selected such that the propagation axis 52 of inspection light coming from the endfaces (through reflection of the illumination light) input face S1 is normal to the input face S1, i.e.:

$${θ}_{{S}_{i n}} = 90 ° + {θ}_{i}$$

wherein θᵢ is the angle of incidence of the illumination light on the optical prism 50, which corresponds to the angle of the angled-polished endface, e.g., herein 8°.

Similarly, the angle θ_{Sout} of the output face S6 is selected such that the propagation axis of inspection light coming out from the optical prism 50 is normal to the output face S6. Assuming the case where the propagation axis at the output of the optical prism 50 is parallel to the optical axis 54 of the inspection microscope, we have:

θ_{S}_{ₒᵤₜ}=90°

The required deflection of the propagation axis 52 is obtained by tilting reflecting surfaces M1 and M3 at different angles relative to the center reflecting surface M2 such that the difference corresponds to θᵢ/2=4°, i.e.:

$${θ}_{M 2 M 3} = {θ}_{M 1 M 2} + {θ}_{i} / 2$$

The angles θ_{M1M2}, θ_{M2M3} of reflecting surfaces M1, M3 may be varied depending on the specific design but are defined as follows:

$${θ}_{M 1 M 2} = 90 ° - {θ}_{R 1} - {θ}_{i}$$

$${θ}_{M 2 M 3} = 90 ° - {θ}_{R 1} - \frac{{θ}_{i}}{2}$$

wherein θ_{R1} is the angle of incidence on reflecting surface M1, which value may vary in accordance with the specific design.

The greater is θ_{R1}, the thinner (vertically) and longer (horizontally) is the optical prism 50 and the longer the reflective surfaces M1, M2, M3 need to be. In order for the reflecting surface M1 to reflect illumination light by total internal reflection, the angle of incidence θ_{R1} on reflecting surface M1 should be selected within the following limit:

$${θ}_{R 1} > 90 ° - \frac{{θ}_{i}}{2} + \frac{[ a sin ( \frac{1}{{n}_{g}} ) - \frac{a sin ( N A )}{{n}_{g}} ]}{2}$$

wherein NA is the numerical aperture of illumination light as reflected on the optical-fiber connector endface under inspection, and ng the refractive index of material used to make the optical prism 50 at the relevant wavelength of illumination light. Assuming a numerical aperture NA of the relay optics of 0.096 and a refractive index ng of 1.52, θ_{R1} Should be greater than 65.26°.

In the illustrated embodiment, angle of incidence on reflecting surface M1 is selected as θ_{R1}=65.36°.

It should be noted that the optical prism 50 may comprise surfaces or portions of surfaces which do not contribute to the optical function of the optical prism 50 in that the inspection light beam neither cross nor reflects thereon. These surfaces, such as surface S7 may therefore be cut at any angle without further deflecting the propagation axis 52. One will notice that in the embodiment of FIG. 7, the first prism 58 is shaped with an angular surface S7 which may take any angle as long as it remains out of the path of the inspection light beam.

Referring to FIG. 10, multifiber connectors are conventionally provided in male and female version, where the difference is the presence of pins 62 protruding from the optical-fiber connector endface (male version) or corresponding holes (female version). A further design constraint may be imposed by the presence and length Lₚᵢₙₛ of such pins 62. In order for these pins 62 not to interfere with the optical prism 50, a distance greater than the length Lₚᵢₙₛ of the pins may need to be provided between the optical prism 50 and the optical-fiber connector endface.

It is noted that the above equations may be modified to account for cases where the angle θₒ of propagation axis at the output of the optical prism 50 would not be null. For example, in such case, the angle θ_{Sout} may be defined as:

$${θ}_{{S}_{o u t}} = 90 ° + {θ}_{o}$$

Similarly, calculations of the angles θ_{M1M2}, θ_{M2M3} of reflecting surfaces M1, M3 can also be adapted to account for an angle θₒ≠0, e.g.:

$${θ}_{M 2 M 3} = {θ}_{M 1 M 2} + ( {θ}_{i} - {θ}_{0} ) / 2$$

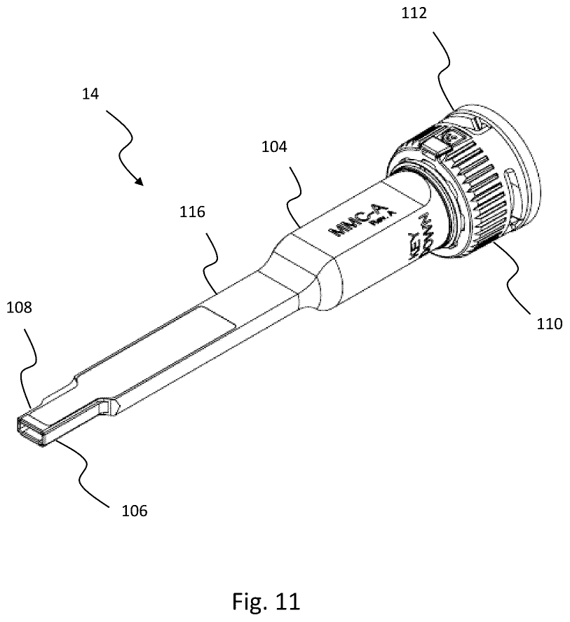

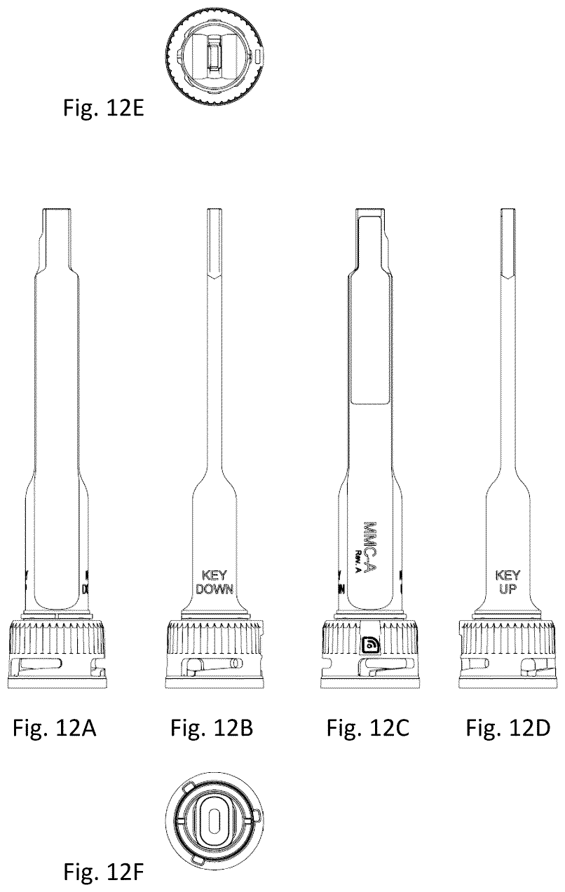

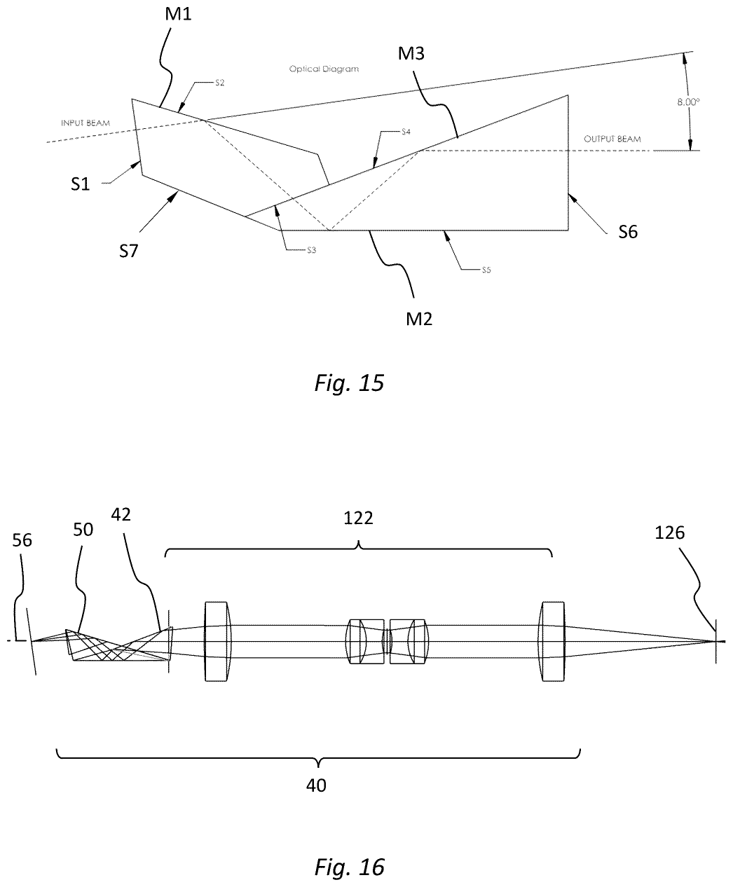

Referring to FIGS. 11, 12, 13 and 14, the adapter tip 14 comprises a housing 104 having a mating interface 106 on its proximal end 108 configured to mechanically engage with the connector adapter 4, a connection mechanism 110 on its distal end 112 to releasably attach to the main housing structure 11 of the inspection microscope device 10 and a hollow light-relaying body 116 (better shown in FIG. 15A) between its proximal end 108 and its distal end 112 allowing light reflected from the optical fiber endfaces to propagate from the optical-fiber endfaces to the objective lens 37 of the inspection microscope 12. As shown, the housing 104 is configured so as to substantially align a center longitudinal axis 56 of the optical-fiber connector 2 with the optical axis 54 of the objective lens 37. The relay optics 40 is disposed in the hollow body 116 of the housing 104, along the imaging path.

The mating interface 106 has outer dimensions that are substantially complementary to inner dimensions of a connector adapter 4 so that it easily inserts into the connector adapter 4 in close proximity with the optical-fiber endfaces to be inspected, and this without direct contact with the optical-fiber endface. Alignment of adapter tip 14 with the optical-fiber connector 2 is at least partly achieved by the small mechanical play of the mating interface 106 within the connector adapter 4.

The adapter tip 14 may be made easily releasably connectable to the main housing structure 11 using a connection mechanism 110 such as a twist and lock mechanism (as shown) or a screw-threaded mechanism for example. The inspection microscope main housing structure 11 has a corresponding connection mechanism allowing easily releasable connection. Of course, other solid and releasable connection mechanisms such as a bayonet connector for example may be used instead.

Referring to FIGS. 11, 12, 13 and 14 and as described hereinabove, the relay optics 40 comprises the multifaceted optical prism 50 disposed in the adapter tip 14 so as to receive inspection light reflected from the angled-polished optical-fiber endfaces during inspection and relay inspection light to the objective lens 37 of the inspection microscope 12. As shown, the multifaceted optical prism 50 is disposed proximate to the optical-fiber endfaces so as to directly receive light reflected from the optical-fiber endfaces.

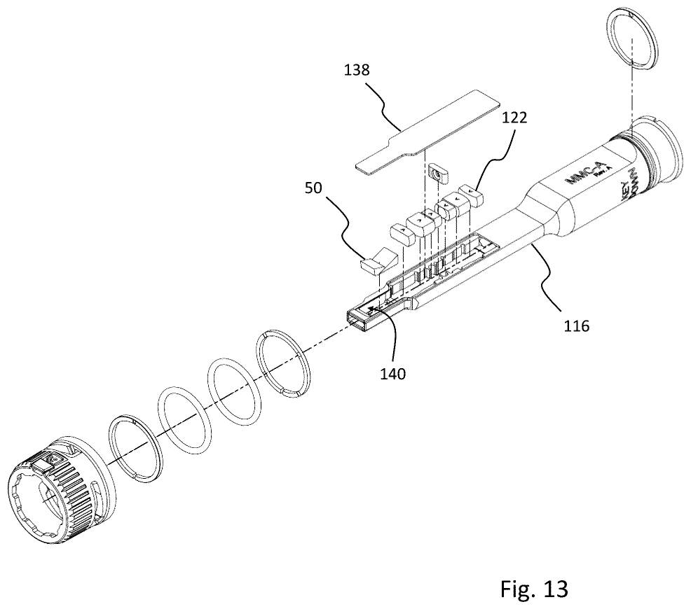

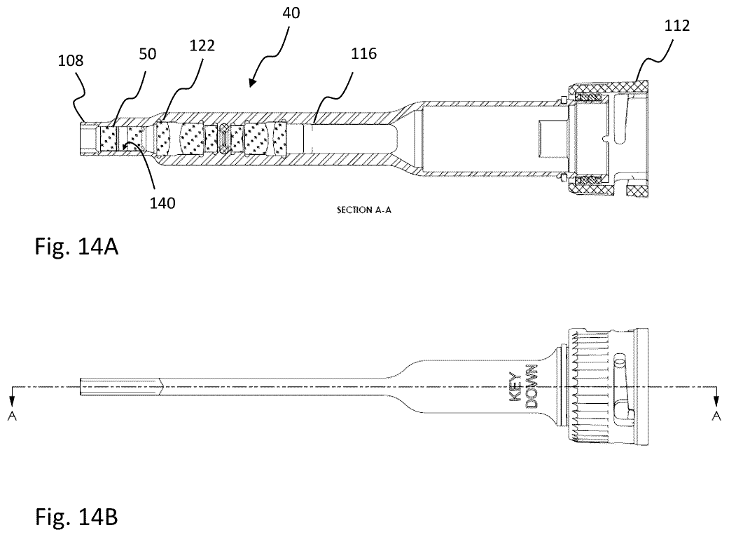

Referring to FIGS. 13, 14A and 14B, the hollow body 116 of the adapter tip 14 may be machined so as to define an internal surface 140 which may serve to align the multifaceted optical prism 50 and the collimating lenses 122 within the body 116. The optical prism 50 may then be affixed in the body 116 by inserting and affixing the optical prism 50 such that the reflecting plane surface M2 abut the internal surface 140 machined in the body 116. The optical prisms 50 can be installed by a simple drop and fix process which does not require any optical alignment, making the adapter tip 14 very easy to assemble. A cover plate 138 covers the cavity to protect the optical components for the surrounding environment.

Referring to FIGS. 15 and 16, various implementations of the multifaceted optical prism 50 and the relay optics 40 are possible in which, e.g., angles of the first reflecting plane surface M1, the second reflecting plane surface M2 and the third reflecting plane surface M3 may vary, as well as the configuration of the collimating lenses 122. FIG. 15 shows a multifaceted optical prism 50 in accordance with another embodiment if which the second reflecting plane surface M2 is buffed or cut out on a portion where the inspection light beam neither cross nor reflects thereon, so as to form an angular surface S7. Such removing of a portion or portions of the optical prism 50 may be used, e.g., to avoid mechanical interference with other components of the adapter tip 14. FIG. 16 shows relay optics 40 in accordance with another embodiment in which the configuration of the collimating lenses 122 to comprise a total of four lenses instead of the six lenses of the configuration of FIG. 8. It shows that the optical design of the relay optics 40 may vary without affecting its function.

The embodiments described above are intended to be exemplary only and one skilled in the art will recognize that numerous modifications can be made to these embodiments without departing from the scope of the invention. Some other implementations which are not illustrated herein may include, for example, the use of the optical prism 50 or an equivalent in the context of an adapter tip designed for inspecting duplex connectors. One may further envisage including two multifaceted optical prisms in a duplex adapter tip, one for each of the two optical fiber enfaces of the duplex connecter to be inspected.

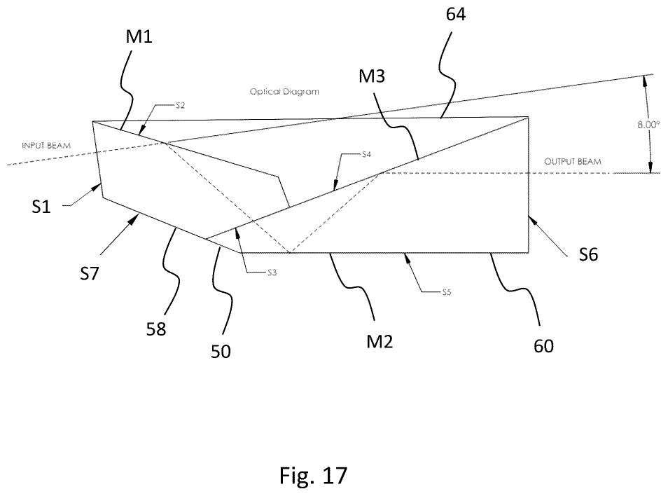

Referring to FIG. 17, in yet another embodiment, the multifaceted optical prism 50 may be constructed by assembling the first prism 58 and the second prism 60 of the embodiment of FIG. 15 to a third optical prism 64. The third optical prism 64 has a shape that is complementary to the combination of the first prism 58 and second prism 60 and is affixed over the first prism 58 and the second prism 60 to protect the first reflecting plane surface M1 and the second reflecting plane surface M2 against dust or scratches due to handling, as well as forming an overall multifaceted optical prism 50 that is more mechanically robust. In the embodiment of FIG. 17, the multifaceted optical prism 50 comprises reflection coatings on surfaces M1 and M2 in order to ensure proper reflection.

### Example of Inspection Microscope Device Architecture

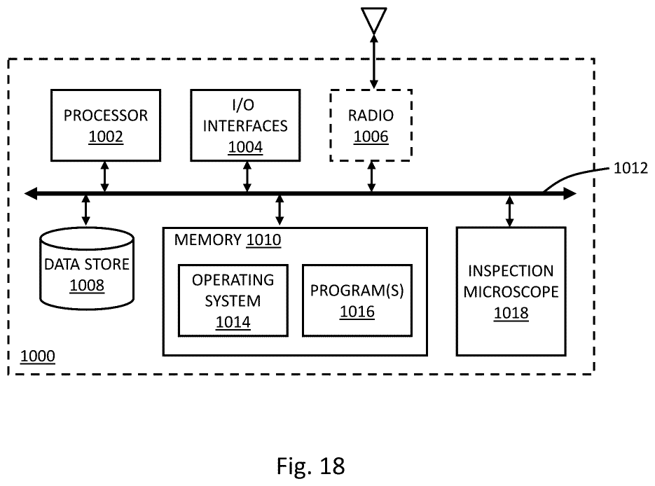

FIG. 18 is a block diagram of an inspection microscope device 1000 which may embody the inspection microscope device 10 of FIGS. 2, 3 and 4. The inspection microscope device 1000 may comprise a digital device that, in terms of hardware architecture, generally includes a processor 1002, input/output (I/O) interfaces 1004, an optional radio 1006, a data store 1008, a memory 1010, as well as an optical test device including an inspection microscope 1018. It should be appreciated by those of ordinary skill in the art that FIG. 18 depicts the inspection microscope device 1000 in a simplified manner, and a practical embodiment may include additional components and suitably configured processing logic to support known or conventional operating features that are not described in detail herein. A local interface 1012 interconnects the major components. The local interface 1012 can be, for example, but not limited to, one or more buses or other wired or wireless connections, as is known in the art. The local interface 1012 can have additional elements, which are omitted for simplicity, such as controllers, buffers (caches), drivers, repeaters, and receivers, among many others, to enable communications. Further, the local interface 1012 may include address, control, and/or data connections to enable appropriate communications among the aforementioned components.

The processor 1002 is a hardware device for executing software instructions. The processor 1002 may comprise one or more processors, including central processing units (CPU), auxiliary processor(s) or generally any device for executing software instructions. When the inspection microscope device 1000 is in operation, the processor 1002 is configured to execute software stored within the memory 1010, to communicate data to and from the memory 1010, and to generally control operations of the inspection microscope device 1000 pursuant to the software instructions. The processor 1002 may implement a controller used to control the operation of the image detectors and the illumination sources of the inspection microscope 1018, e.g., to capture images from each image detector in sequence while also activating the illumination sources in sequence. The controller may further be used to control the actuator used to move the focusing lens 35 for adjusting a focus of the objective lens system.

In an embodiment, the processor 1002 may include an optimized mobile processor such as optimized for power consumption and mobile applications. The I/O interfaces 1004 can be used to receive user input from and/or for providing system output. User input can be provided via, for example, a keypad, a touch screen, a scroll ball, a scroll bar, buttons, barcode scanner, and the like. System output can be provided via a display device such as a liquid crystal display (LCD), touch screen, and the like, via one or more LEDs or a set of LEDs, or via one or more buzzer or beepers, etc. The I/O interfaces 1004 can be used to display a graphical user interface (GUI) that enables a user to interact with the inspection microscope device 1000 and/or output at least one of the values derived by the inspection microscope analyzing software.

The radio 1006, if included, may enable wireless communication to an external access device or network. Any number of suitable wireless data communication protocols, techniques, or methodologies can be supported by the radio 1006, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); NarrowBand Internet of Things (NB-IoT); Long Term Evolution Machine Type Communication (LTE-M); magnetic induction; satellite data communication protocols; and any other protocols for wireless communication. The data store 1008 may be used to store data, such as inspection microscope images. The data store 1008 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 1008 may incorporate electronic, magnetic, optical, and/or other types of storage media.

The memory 1010 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 1010 may incorporate electronic, magnetic, optical, and/or other types of storage media. Note that the memory 1010 may have a distributed architecture, where various components are situated remotely from one another, but can be accessed by the processor 1002. The software in memory 1010 can include one or more computer programs, each of which includes an ordered listing of executable instructions for implementing logical functions. In the example of FIG. 18, the software in the memory 1010 includes a suitable operating system (O/S) 1014 and computer programs 1016. The operating system 1014 essentially controls the execution of other computer programs and provides scheduling, input-output control, file and data management, memory management, and communication control and related services. The program(s) 1016 may include various applications, add-ons, etc. configured to provide end-user functionality with the inspection microscope device 1000. For example, example programs 1016 may include a web browser to connect with a server for transferring inspection result data files, a dedicated inspection microscope application configured to control inspection microscope measurements by the inspection microscope 1018, set image acquisition parameters, analyze connector endface images obtained by the inspection microscope 1018 and display a GUI related to the inspection microscope device 1000.

It is noted that, in some embodiments, the I/O interfaces 1004 may be provided via a physically distinct mobile device (not shown), such as a handheld computer, a smartphone, a tablet computer, a laptop computer, a wearable computer or the like, e.g., communicatively coupled to the inspection microscope device 1000 via the radio 1006. In such cases, at least some of the programs 1016 may be located in a memory of such a mobile device, for execution by a processor of the physically distinct device. The mobile may then also include a radio and be used to transfer measurement data files toward a remote test application residing, e.g., on a server.

The embodiments described above are intended to be exemplary only and one skilled in the art will recognize that numerous modifications can be made to these embodiments without departing from the scope of the invention. The scope of the invention is therefore intended to be limited solely by the appended claims.

1. An adapter tip to be employed with an optical-fiber connector endface inspection microscope comprising an objective lens, for imaging at least one angled-polished optical-fiber endface of an optical-fiber connector, the adapter tip comprising:
a housing having:
a mating interface on one end, configured to mechanically engage with the optical-fiber connector for inspecting the optical-fiber endface;
a connection mechanism on the other end, to releasably attach to the inspection microscope; and
a hollow body extending between the one end and the other end and allowing inspection light reflected from the optical-fiber endface to propagate to the objective lens of the inspection microscope; and
relay optics disposed in said hollow body of said housing and comprising a multifaceted optical prism disposed so as to receive inspection light reflected from said angled-polished optical-fiber endface during inspection and relay said inspection light to an objective lens of the inspection microscope, the multifaceted optical prism defining a first reflecting plane surface, a second reflecting plane surface and a third reflecting plane surface, wherein said first reflecting plane surface and said third reflecting plane surface are tilted in opposite directions relative to said second reflecting plane surface so as to deflect a propagation axis of said inspection light towards an optical axis of the objective lens through reflection on said first reflecting plane surface, said second reflecting plane surface and said third reflecting plane surface.

1. The adapter tip as claimed in claim 1, wherein said optical-fiber connector is a multifiber optical-fiber connector comprising multiple angled-polished optical-fiber endfaces.

2. The adapter tip as claimed in claim 1, wherein said housing is configured so as to substantially align a center longitudinal axis of said optical-fiber connector with the optical axis of the objective lens.

3. The adapter tip as claimed in claim 1, wherein said first reflecting plane surface is tilted relative to said second reflecting plane surface with a first angle and said third reflecting plane surface is tilted relative to said second reflecting plane surface with a second angle, wherein said first angle and said second angle have a difference of about 4 degrees.

4. The adapter tip as claimed in claim 4, wherein said first reflecting plane surface receives inspection light on an angle of incidence that is not normal thereto and reflects inspection light toward said second reflecting plane surface, which reflects inspection light toward said third reflecting plane surface, which in turn reflects inspection light toward said inspection microscope and substantially aligned and centered on the optical axis of the objective lens of the inspection microscope.

5. The adapter tip as claimed in claim 5, wherein inspection light is reflected on said first reflecting plane surface, said second reflecting plane surface and said third reflecting plane surface by total internal reflection.

6. The adapter tip as claimed in claim 5, wherein said first reflecting plane surface, said second reflecting plane surface and said third reflecting plane surface each comprises a reflection coating.

7. The adapter tip as claimed in claim 1, wherein said second reflecting plane surface is substantially parallel to the optical axis of the objective lens and wherein said multifaceted optical prism is affixed in said housing such that said second reflecting plane surface abuts an internal surface machined in said housing.

8. The adapter tip as claimed in claim 1, wherein said multifaceted optical prism comprises a first prism and second prism joint to one another so as to form said multifaceted optical prism.

9. The adapter tip as claimed in claim 9, wherein said first prism comprises a first surface defining said first reflecting plane surface and said second prism comprises a second surface defining said second reflecting plane surface and a third surface defining said third reflecting plane surface.

10. The adapter tip as claimed in claim 10, wherein said first prism further comprises a fourth plane surface and wherein said first prism and said second prism are joint to one another by affixing said fourth plane surface on a portion of said third surface.

11. The adapter tip as claimed in claim 1, wherein said relay optics comprises collimating lenses, said multifaceted optical prism being disposed in-between said optical-fiber connector under inspection and said collimating lenses.

12. The adapter tip as claimed in claim 12, wherein said relay optics produces an intermediate image plane between said relay optics and the objective lens of the inspection microscope.

13. An optical-fiber connector endface inspection microscope system for imaging at least one angled-polished optical-fiber endface of an optical-fiber connector, the inspection microscope system comprising:
an optical-fiber connector endface inspection microscope device having an objective lens; and
an adapter tip connectable to the optical-fiber connector endface inspection microscope device and comprising:
a housing having:
a mating interface on one end, configured to mechanically engage with the optical-fiber connector for inspecting the optical-fiber endface;
a connection mechanism on the other end, to releasably attach to the inspection microscope; and
a hollow body extending between the one end and the other end and allowing inspection light reflected from the optical-fiber endface to propagate to the objective lens of the inspection microscope; and
relay optics disposed in said hollow body of said housing and comprising a multifaceted optical prism disposed so as to receive inspection light reflected from said angled-polished optical-fiber endface during inspection and relay said inspection light to an objective lens of the inspection microscope, the multifaceted optical prism defining a first reflecting plane surface, a second reflecting plane surface and a third reflecting plane surface, wherein said first reflecting plane surface and said third reflecting plane surface are tilted in opposite directions relative to said second reflecting plane surface so as to deflect a propagation axis of said inspection light towards an optical axis of the objective lens through reflection on said first reflecting plane surface, said second reflecting plane surface and said third reflecting plane surface.

14. The optical-fiber connector endface inspection microscope system as claimed in claim 14, wherein said optical-fiber connector is a multifiber optical-fiber connector comprising multiple angled-polished optical-fiber endfaces and wherein said optical-fiber connector endface inspection microscope device comprises a first image sensor and a second image sensor, disposed so as to capture images of respective regions over the optical-fiber connector endface.

15. The optical-fiber connector endface inspection microscope system as claimed in claim 14, wherein said housing is configured so as to substantially align a center longitudinal axis of said optical-fiber connector with the optical axis of the objective lens.

16. The optical-fiber connector endface inspection microscope system as claimed in claim 14, wherein said first reflecting plane surface is tilted relative to said second reflecting plane surface with a first angle and said third reflecting plane surface is tilted relative to said second reflecting plane surface with a second angle, wherein said first angle and said second angle have a difference of about 4 degrees.

17. The optical-fiber connector endface inspection microscope system as claimed in claim 17, wherein said first reflecting plane surface receives inspection light on an angle of incidence that is not normal thereto and reflects inspection light toward said second reflecting plane surface, which reflects inspection light toward said third reflecting plane surface, which in turn reflects inspection light toward said inspection microscope and substantially aligned and centered on the optical axis of the objective lens of the inspection microscope.

18. The optical-fiber connector endface inspection microscope system as claimed in claim 18, wherein inspection light is reflected on said first reflecting plane surface, said second reflecting plane surface and said third reflecting plane surface via total internal reflection.

19. The optical-fiber connector endface inspection microscope system as claimed in claim 14, wherein said multifaceted optical prism comprises a first prism and second prism joint to one another so as to form said multifaceted optical prism.
